(19) United States
(12) Patent Application Publication
(10) Pub. No.: US 2011/0306252 A1
(43) Pub. Date: Dec. 15, 2011

(54) SPRING FINGER GROUNDING COMPONENT AND METHOD OF MANUFACTURE

(75) Inventors: Chao Chen, Waterloo (CA); Richard Changchun Zhang, Waterloo (CA)

(73) Assignee: RESEARCH IN MOTION LIMITED, Waterloo (CA)

(21) Appl. No.: 12/816,033

(22) Filed: Jun. 15, 2010

(51) Int. Cl. H01R 4/48

(52) U.S. Cl. 439/834

(57) ABSTRACT

A grounding component is provided for grounding electronic components. The grounding component includes: a base; a channel formed within the base; and a spring finger extending from the base, the spring finger having a fixed end and a free end. When the spring finger is in a first undepressed position, a knuckled portion of the spring finger lies proud of the base, and the free end of the spring finger lies substantially within the channel. A method for manufacturing the grounding component is also provided.

### RELEVANT FIELD

The field of the invention relates generally to components used to provide a reference ground to electronic components.

### BACKGROUND

Electronic components must typically be grounded. Grounding components may be utilized to accomplish this. Continuous electrical engagement between the electronic component and the grounding component is required for the grounding component to be effective.

### BRIEF DESCRIPTION OF THE DRAWINGS

Embodiments are described in further detail below, by way of example only, with reference to the accompanying drawings, in which:

FIG. 1 is a block diagram of a mobile device in one example implementation;

FIG. 2 is a block diagram of a communication subsystem component of the mobile device of FIG. 1;

FIG. 3 is a block diagram of a node of a wireless network;

FIG. 4A is a perspective view of a grounding component according to an embodiment of the present invention;

FIG. 4B is a side section view of the grounding component of FIG. 4A taken along section line A4-A4 and in the direction indicated, and illustrates the grounding component in a first undepressed position;

FIG. 4C is a side section view of the grounding component of FIG. 4A taken along section line A4-A4 and in the direction indicated, and illustrates the grounding component in a second depressed position;

FIG. 5A is a perspective view of a grounding component according to another embodiment of the present invention;

FIG. 5B is a side section view of the grounding component of FIG. 5A taken along section line A5-A5 and in the direction indicated, and illustrates the grounding component in a first undepressed position;

FIG. 5C is a side section view of the grounding component of FIG. 5A taken along section line A5-A5 and in the direction indicated, and illustrates the grounding component in a second depressed position;

FIG. 5D is a side section view of the grounding component of FIG. 5A taken along section line A5-A5 and in the direction indicated, and depicts an electronic component causing the grounding component to assume the second depressed position;

FIG. 6A is a perspective view of a grounding component according to another embodiment of the present invention;

FIG. 6B is a side section view of the grounding component of FIG. 6A taken along section line A6-A6 and in the direction indicated, and illustrates the grounding component in a first undepressed position;

FIG. 6C is a side section view of the grounding component of FIG. 6A taken along section line A6-A6 and in the direction indicated, and illustrates the grounding component in a second depressed position;

FIG. 7 is a logical flow diagram of a method for manufacturing a grounding component according to an embodiment of the present invention; and

FIG. 8 is a logical flow diagram of a method of grounding an electronic component according to an embodiment of the present invention.

### DETAILED DESCRIPTION

In one broad aspect, there is provided a grounding component. The grounding component includes: a grounded base; a channel formed within the base; and a spring finger extending from the base, the spring finger having a fixed end and a free end. When the spring finger is in a first undepressed position, a knuckled portion of the spring finger lies proud of the base, and the free end of the spring finger lies substantially within the channel.

In some instances, the base of the grounding component may comprise a top plate secured to a bottom plate. In such instances, the channel formed in the base may extend through the entire thickness of the top plate. Furthermore, the spring finger may be stamped from the top plate and displaced to form the channel within the top plate.

In other instances, when the spring finger is in a second depressed position, an electrical connection may be established between the bottom plate and the free end of the spring finger.

The fixed end of the spring finger may be welded to the base and may comprise a conductive material. The top plate and bottom plate may be secured together using an adhesive, or may be welded together to form a weldment. Where an adhesive is used, the adhesive may be conductive or non-conductive. Where a non-conductive adhesive is used, an electrical connection may be established between the top plate and the bottom plate through the spring finger, when the spring finger is in the second depressed position.

In some instances, the grounding component may have a plurality of spring fingers and channels, comprising at least one second channel and at least one second spring finger.

In another broad aspect, there is provided a grounding system comprising: a grounded base having a top plate secured to a bottom plate; a channel formed within the top plate; and a cantilevered member extending from the base, the cantilevered member being flexibly biased towards a first undepressed position. When the cantilevered member is in a second depressed position, an electrical connection may be established between the cantilevered member and the bottom plate.

In some instances, the cantilevered member may have a free end and a fixed end, and when the cantilevered member is in the first undepressed position, a knuckled portion of the cantilevered member may lie proud of the base, and the free end of the cantilevered member may lie within the channel. When the cantilevered member is in the first undepressed position, in some embodiments the top plate and the bottom plate may not be in electrical communication with one another.

In other instances, the grounding system may be further configured for receivably mounting an electronic component to the base such that when the electronic component is mounted to the base, an electrical connection may be established between an electrical contact point of the electronic component and the base through the cantilevered member. The electronic component may comprise a printed circuit board assembly. Further, a keypad assembly may be coupled to the printed circuit board assembly.

In another broad aspect, there is provided an assembly for grounding an electronic component comprising: a grounded base; a channel formed in the base; a cantilevered member extending from the base, the cantilevered member being flexibly biased towards a first position, and having a fixed end and a free end. When the cantilevered member is in an undepressed position, a knuckled portion of the cantilevered member may lie proud of the base and the free end of the cantilevered member may lie substantially within the channel. When an electronic component is mounted to the base, an electrical connection may be established between the base and the electronic component through the cantilevered member.

In some instances, the cantilevered member may comprise a conductive material. In other instances, at least a portion of the base comprises a conductive material for reducing electro-magnetic interference emissions generated from the electronic component. The electronic component may be a printed circuit board assembly, and the printed circuit board assembly may be mounted within a mobile device. Further, a keypad assembly may be coupled to the printed circuit board assembly.

According to another broad aspect, there is provided a method of manufacture for a grounding component. The method comprises the steps of: providing a grounded base having a top plate and a bottom plate; stamping a spring finger from a portion of the top plate, the spring finger having a fixed end and a free end; displacing the spring finger to form a channel within the top plate; forming a knuckled portion in the spring finger; and configuring the spring finger such that the knuckled portion lies proud of the base and the free end lies substantially within the channel.

According to another broad aspect, there is provided another method of manufacturing a grounding component. The method comprises the steps of: providing a base having a channel; providing a spring finger having a first end and a second end; coupling the first end of the spring finger to the base; positioning the second end of the spring finger substantially within the channel; positioning a knuckled portion of the spring finger proud of the base. In some instances the first end of the spring finger may be welded to the base. In other instances, an adhesive may be used to couple the first end of the spring finger to the base.

In another broad aspect, there is provided a method for grounding an electronic component. The method comprises the steps of: providing a grounded base having a channel; configuring a spring finger to extend from a portion of the base, wherein when in an undepressed position, a free end of the spring finger lies substantially within the channel and a knuckled portion of the spring finger lies proud of the base; and operatively coupling an electrical contact point of the electronic component to the knuckled portion of the spring finger to establish an electrical connection between the electronic component and the base through the spring finger.

Some embodiments of the systems and methods described herein make reference to a mobile device. A mobile device may be a two-way communication device with advanced data communication capabilities having the capability to communicate with other computer systems. A mobile device may also include the capability for voice communications. Depending on the functionality provided by a mobile device, it may be referred to as a data messaging device, a two-way pager, a cellular telephone with data messaging capabilities, a wireless Internet appliance, or a data communication device (with or without telephony capabilities), for example. A mobile device may communicate with other devices through a network of transceiver stations.

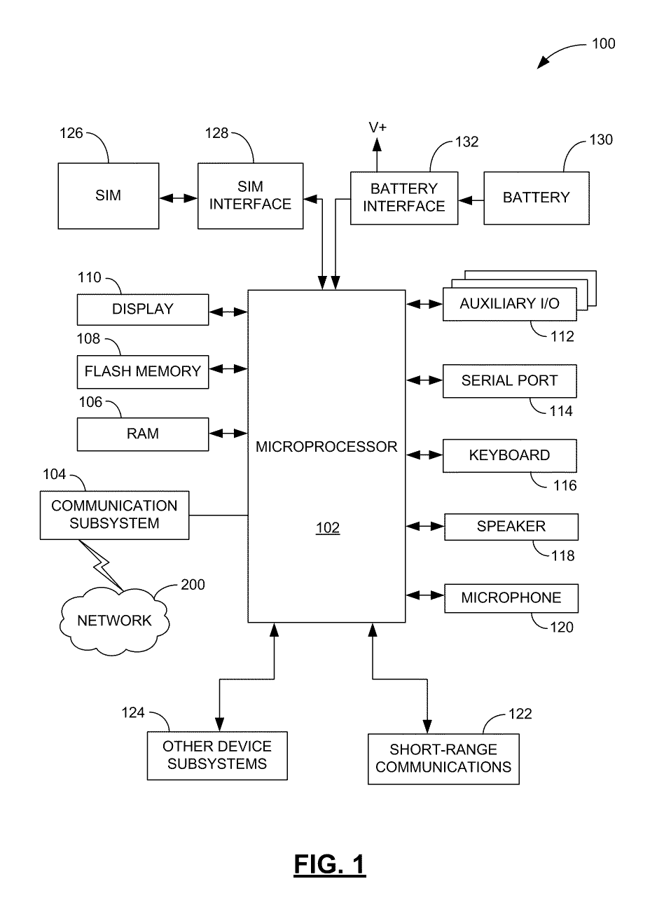

To aid the reader in understanding the structure of a mobile device and how it communicates with other devices, reference is made to FIGS. 1 through 3.

Referring first to FIG. 1, a block diagram of a mobile device in one example implementation is shown generally as 100. Mobile device 100 comprises a number of components, the controlling component being microprocessor 102. Microprocessor 102 controls the overall operation of mobile device 100. Communication functions, including data and voice communications, may be performed through communication subsystem 104. Communication subsystem 104 may be configured to receive messages from and send messages to a wireless network 200. In one example implementation of mobile device 100, communication subsystem 104 may be configured in accordance with the Global System for Mobile Communication (GSM) and General Packet Radio Services (GPRS) standards. The GSM/GPRS wireless network is used worldwide and it is expected that these standards may be supplemented or superseded eventually by Enhanced Data GSM Environment (EDGE) and Universal Mobile Telecommunications Service (UMTS), and Ultra Mobile Broadband (UMB), etc. New standards are still being defined, but it is believed that they will have similarities to the network behaviour described herein, and it will also be understood by persons skilled in the art that the embodiments of the present disclosure are intended to use any other suitable standards that are developed in the future. The wireless link connecting communication subsystem 104 with network 200 represents one or more different Radio Frequency (RF) channels, operating according to defined protocols specified for GSM/GPRS communications. With newer network protocols, these channels are capable of supporting both circuit switched voice communications and packet switched data communications.

Although the wireless network associated with mobile device 100 is a GSM/GPRS wireless network in one example implementation of mobile device 100, other wireless networks may also be associated with mobile device 100 in variant implementations. Different types of wireless networks that may be employed include, for example, data-centric wireless networks, voice-centric wireless networks, and dual-mode networks that can support both voice and data communications over the same physical base stations. Combined dual-mode networks include, but are not limited to, Code Division Multiple Access (CDMA) or CDMA2000 networks, GSM/GPRS networks (as mentioned above), and future third-generation (3G) networks like EDGE and UMTS. Some older examples of data-centric networks include the Mobitex™ Radio Network and the DataTAC™ Radio Network. Examples of older voice-centric data networks include Personal Communication Systems (PCS) networks like GSM and Time Division Multiple Access (TDMA) systems. Other network communication technologies that may be employed include, for example, Integrated Digital Enhanced Network (iDEN™), Evolution-Data Optimized (EV-DO), and High Speed Packet Access (HSPA), etc.

Microprocessor 102 may also interact with additional subsystems such as a Random Access Memory (RAM) 106, flash memory 108, display 110, auxiliary input/output (I/O) subsystem 112, serial port 114, keyboard 116, speaker 118, microphone 120, short-range communications subsystem 122 and other device subsystems 124.

Some of the subsystems of mobile device 100 perform communication-related functions, whereas other subsystems may provide “resident” or on-device functions. By way of example, display 110 and keyboard 116 may be used for both communication-related functions, such as entering a text message for transmission over network 200, as well as device-resident functions such as a calculator or task list. Operating system software used by microprocessor 102 is typically stored in a persistent store such as flash memory 108, which may alternatively be a read-only memory (ROM) or similar storage element (not shown). Those skilled in the art will appreciate that the operating system, specific device applications, or parts thereof, may be temporarily loaded into a volatile store such as RAM 106.

Mobile device 100 may send and receive communication signals over network 200 after network registration or activation procedures have been completed. Network access may be associated with a subscriber or user of a mobile device 100. To identify a subscriber, mobile device 100 may provide for a Subscriber Identity Module (“SIM”) card 126 to be inserted in a SIM interface 128 in order to communicate with a network. SIM 126 may be one example type of a conventional “smart card” used to identify a subscriber of mobile device 100 and to personalize the mobile device 100, among other things. Without SIM 126, mobile device 100 may not be fully operational for communication with network 200. By inserting SIM 126 into SIM interface 128, a subscriber may access all subscribed services. Services may include, without limitation: web browsing and messaging such as e-mail, voice mail, Short Message Service (SMS), and Multimedia Messaging Services (MMS). More advanced services may include, without limitation: point of sale, field service and sales force automation. SIM 126 may include a processor and memory for storing information. Once SIM 126 is inserted in SIM interface 128, it may be coupled to microprocessor 102. In order to identify the subscriber, SIM 126 may contain some user parameters such as an International Mobile Subscriber Identity (IMSI). By using SIM 126, a subscriber may not necessarily be bound by any single physical mobile device. SIM 126 may store additional subscriber information for a mobile device as well, including datebook (or calendar) information and recent call information.

Mobile device 100 may be a battery-powered device and may comprise a battery interface 132 for receiving one or more rechargeable batteries 130. Battery interface 132 may be coupled to a regulator (not shown), which assists battery 130 in providing power V+ to mobile device 100. Although current technology makes use of a battery, future technologies such as micro fuel cells may provide power to mobile device 100. In some embodiments, mobile device 100 may be solar-powered.

Microprocessor 102, in addition to its operating system functions, enables execution of software applications on mobile device 100. A set of applications that control basic device operations, including data and voice communication applications, may be installed on mobile device 100 during its manufacture. Another application that may be loaded onto mobile device 100 is a personal information manager (PIM). A PIM has functionality to organize and manage data items of interest to a subscriber, such as, but not limited to, e-mail, calendar events, voice mails, appointments, and task items. A PIM application has the ability to send and receive data items via wireless network 200. PIM data items may be seamlessly integrated, synchronized, and updated via wireless network 200 with the mobile device subscriber's corresponding data items stored and/or associated with a host computer system. This functionality may create a mirrored host computer on mobile device 100 with respect to such items. This can be particularly advantageous where the host computer system is the mobile device subscriber's office computer system.

Additional applications may also be loaded onto mobile device 100 through network 200, auxiliary I/O subsystem 112, serial port 114, short-range communications subsystem 122, or any other suitable subsystem 124. This flexibility in application installation increases the functionality of mobile device 100 and may provide enhanced on-device functions, communication-related functions, or both. For example, secure communication applications may enable electronic commerce functions and other such financial transactions to be performed using mobile device 100.

Serial port 114 enables a subscriber to set preferences through an external device or software application and extends the capabilities of mobile device 100 by providing for information or software downloads to mobile device 100 other than through a wireless communication network. The alternate download path may, for example, be used to load an encryption key onto mobile device 100 through a direct and thus reliable and trusted connection to provide secure device communication.

Short-range communications subsystem 122 provides for communication between mobile device 100 and different systems or devices, without the use of network 200. For example, subsystem 122 may include an infrared device and associated circuits and components for short-range communication. Examples of short range communication include standards developed by the Infrared Data Association (IrDA), Bluetooth®, and the 802.11 family of standards (Wi-Fi®) developed by IEEE.

In use, a received signal such as a text message, an e-mail message, or web page download is processed by communication subsystem 104 and input to microprocessor 102. Microprocessor 102 then processes the received signal for output to display 110 or alternatively to auxiliary I/O subsystem 112. A subscriber may also compose data items, such as e-mail messages, for example, using keyboard 116 in conjunction with display 110 and possibly auxiliary I/O subsystem 112. Auxiliary subsystem 112 may include devices such as: a touch screen, mouse, track ball, infrared fingerprint detector, or a roller wheel with dynamic button pressing capability. Keyboard 116 may comprise an alphanumeric keyboard and/or telephone-type keypad, for example. A composed item may be transmitted over network 200 through communication subsystem 104.

For voice communications, the overall operation of mobile device 100 may be substantially similar, except that the received signals may be processed and output to speaker 118, and signals for transmission may be generated by microphone 120. Alternative voice or audio I/O subsystems, such as a voice message recording subsystem, may also be implemented on mobile device 100. Although voice or audio signal output is accomplished primarily through speaker 118, display 110 may also be used to provide additional information such as the identity of a calling party, duration of a voice call, or other voice call related information.

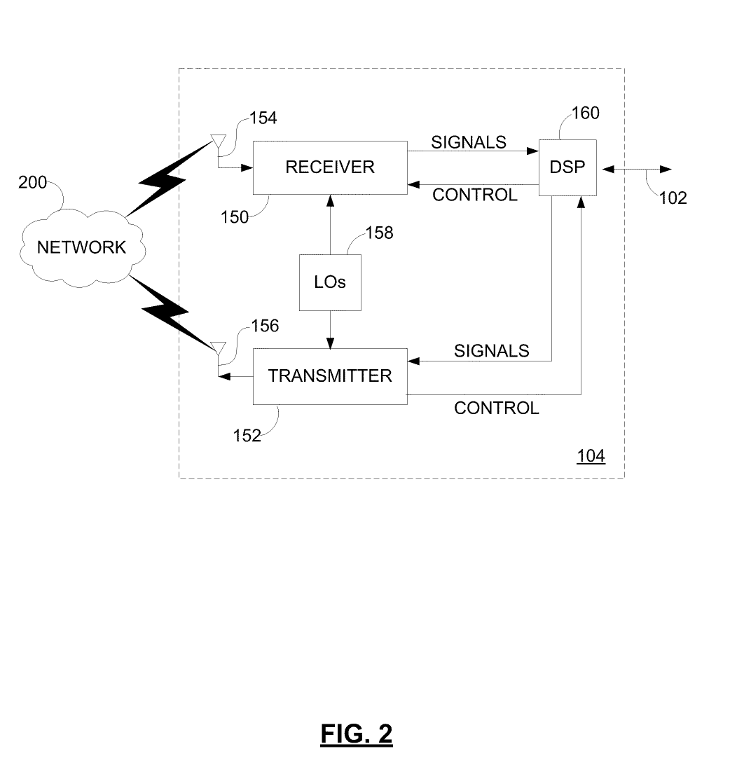

Referring now to FIG. 2, a block diagram of the communication subsystem component 104 of FIG. 1 is shown. Communication subsystem 104 may comprise a receiver 150, a transmitter 152, one or more embedded or internal antenna elements 154, 156, Local Oscillators (LOs) 158, and a processing module such as a Digital Signal Processor (DSP) 160.

The particular design of communication subsystem 104 is dependent upon the network 200 in which mobile device 100 is intended to operate; thus, it should be understood that the design illustrated in FIG. 2 serves only as one example. Signals received by antenna 154 through network 200 are input to receiver 150, which may perform such common receiver functions as signal amplification, frequency down conversion, filtering, channel selection, and analog-to-digital (A/D) conversion. A/D conversion of a received signal allows more complex communication functions such as demodulation and decoding to be performed in DSP 160. In a similar manner, signals to be transmitted are processed, including modulation and encoding, by DSP 160. These DSP-processed signals are input to transmitter 152 for digital-to-analog (D/A) conversion, frequency up conversion, filtering, amplification and transmission over network 200 via antenna 156. DSP 160 not only processes communication signals, but also provides for receiver and transmitter control. For example, the gains applied to communication signals in receiver 150 and transmitter 152 may be adaptively controlled through automatic gain control algorithms implemented in DSP 160.

The wireless link between mobile device 100 and a network 200 may contain one or more different channels, typically different RF channels, and associated protocols used between mobile device 100 and network 200. A RF channel is generally a limited resource, typically due to limits in overall bandwidth and limited battery power of mobile device 100.

When mobile device 100 is fully operational, transmitter 152 may be typically keyed or turned on only when it is sending to network 200 and may otherwise be turned off to conserve resources. Similarly, receiver 150 may be periodically turned off to conserve power until it is needed to receive signals or information (if at all) during designated time periods.

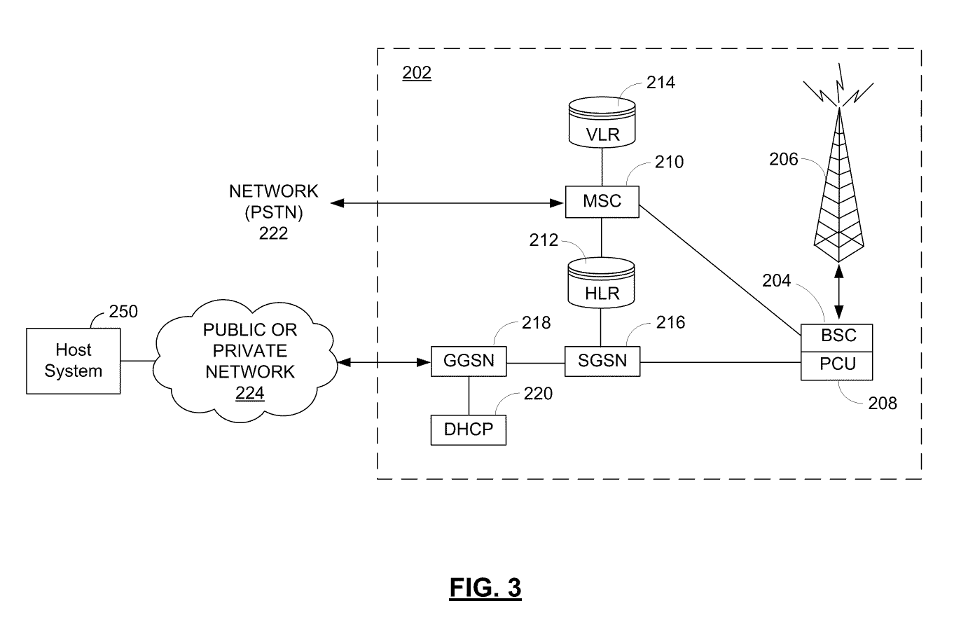

Referring now to FIG. 3, a block diagram of a node of a wireless network is shown as 202. In practice, network 200 comprises one or more nodes 202. Mobile device 100 communicates with a node 202 within wireless network 200. In the example implementation of FIG. 3, node 202 is configured in accordance with GPRS and GSM technologies; however, in other embodiments, different standards may be implemented as discussed in more detail above. Node 202 includes a base station controller (BSC) 204 with an associated tower station 206, a Packet Control Unit (PCU) 208 added for GPRS support in GSM, a Mobile Switching Center (MSC) 210, a Home Location Register (HLR) 212, a Visitor Location Registry (VLR) 214, a Serving GPRS Support Node (SGSN) 216, a Gateway GPRS Support Node (GGSN) 218, and a Dynamic Host Configuration Protocol (DHCP) server 220. This list of components is not meant to be an exhaustive list of the components of every node 202 within a GSM/GPRS network, but rather a list of components that are commonly used in communications through network 200.

In a GSM network, MSC 210 is coupled to BSC 204 and to a landline network, such as a Public Switched Telephone Network (PSTN) 222 to satisfy circuit switched requirements. The connection through PCU 208, SGSN 216 and GGSN 218 to the public or private network (Internet) 224 (also referred to herein generally as a shared network infrastructure) represents the data path for GPRS capable mobile devices. In a GSM network extended with GPRS capabilities, BSC 204 also contains a Packet Control Unit (PCU) 208 that connects to SGSN 216 to control segmentation, radio channel allocation and to satisfy packet switched requirements. To track mobile device location and availability for both circuit switched and packet switched management, HLR 212 is shared between MSC 210 and SGSN 216. Access to VLR 214 is controlled by MSC 210.

Station 206 may be a fixed transceiver station. Station 206 and BSC 204 together may form the fixed transceiver equipment. The fixed transceiver equipment provides wireless network coverage for a particular coverage area commonly referred to as a “cell”. The fixed transceiver equipment transmits communication signals to and receives communication signals from mobile devices within its cell via station 206. The fixed transceiver equipment normally performs such functions as modulation and possibly encoding and/or encryption of signals to be transmitted to the mobile device in accordance with particular, usually predetermined, communication protocols and parameters, under control of its controller. The fixed transceiver equipment similarly demodulates and possibly decodes and decrypts, if necessary, any communication signals received from mobile device 100 within its cell. Communication protocols and parameters may vary between different nodes. For example, one node may employ a different modulation scheme and operate at different frequencies than other nodes.

For all mobile devices 100 registered with a specific network, permanent configuration data such as a user profile may be stored in HLR 212. HLR 212 may also contain location information for each registered mobile device and can be queried to determine the current location of a mobile device. MSC 210 is responsible for a group of location areas and stores the data of the mobile devices currently in its area of responsibility in VLR 214. Further VLR 214 also contains information on mobile devices that are visiting other networks. The information in VLR 214 includes part of the permanent mobile device data transmitted from HLR 212 to VLR 214 for faster access. By moving additional information from a remote HLR 212 node to VLR 214, the amount of traffic between these nodes can be reduced so that voice and data services can be provided with faster response times while requiring less use of computing resources.

SGSN 216 and GGSN 218 are elements that may be added for GPRS support; namely packet switched data support, within GSM. SGSN 216 and MSC 210 have similar responsibilities within wireless network 200 by keeping track of the location of each mobile device 100. SGSN 216 also performs security functions and access control for data traffic on network 200. GGSN 218 provides internetworking connections with external packet switched networks and connects to one or more SGSNs 216 via an Internet Protocol (IP) backbone network operated within the network 200. During normal operations, a given mobile device 100 performs a “GPRS Attach” to acquire an IP address and to access data services. This normally is not present in circuit switched voice channels as Integrated Services Digital Network (ISDN) addresses may be generally used for routing incoming and outgoing calls. Currently, GPRS capable networks may use private, dynamically assigned IP addresses, thus requiring a DHCP server 220 connected to the GGSN 218. There are many mechanisms for dynamic IP assignment, including using a combination of a Remote Authentication Dial-In User Service (RADIUS) server and DHCP server, for example. Once the GPRS Attach is complete, a logical connection is established from a mobile device 100, through PCU 208, and SGSN 216 to an Access Point Node (APN) within GGSN 218, for example. The APN represents a logical end of an IP tunnel that can either access direct Internet compatible services or private network connections. The APN also represents a security mechanism for network 200, insofar as each mobile device 100 must be assigned to one or more APNs and mobile devices 100 cannot generally exchange data without first performing a GPRS Attach to an APN that it has been authorized to use. The APN may be considered to be similar to an Internet domain name such as “myconnection.wireless.com”.

Once the GPRS Attach is complete, a tunnel is created and all traffic is exchanged within standard IP packets using any protocol that can be supported in IP packets. This includes tunneling methods such as IP over IP as in the case with some IPSecurity (IPsec) connections used with Virtual Private Networks (VPN). These tunnels are also referred to as Packet Data Protocol (PDP) Contexts and there are a limited number of these available in the network 200. To maximize use of the PDP Contexts, network 200 will run an idle timer for each PDP Context to determine if there is a lack of activity. When a mobile device 100 is not using its PDP Context, the PDP Context can be deallocated and the IP address returned to the IP address pool managed by DHCP server 220.

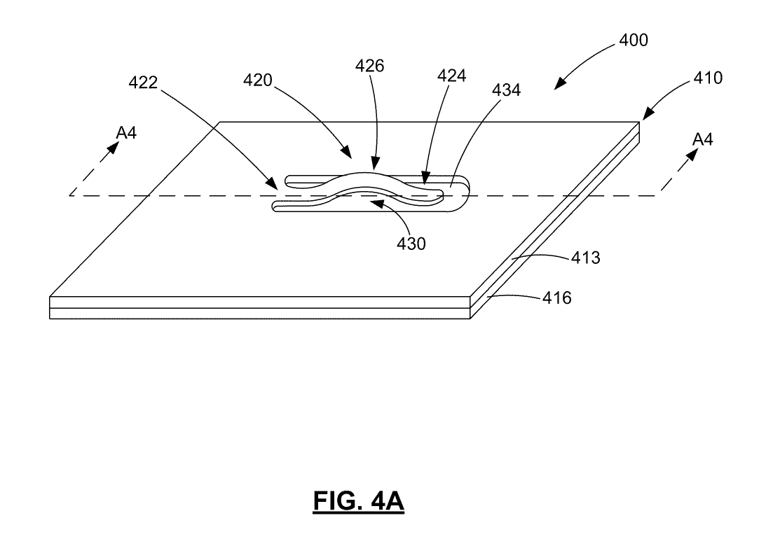

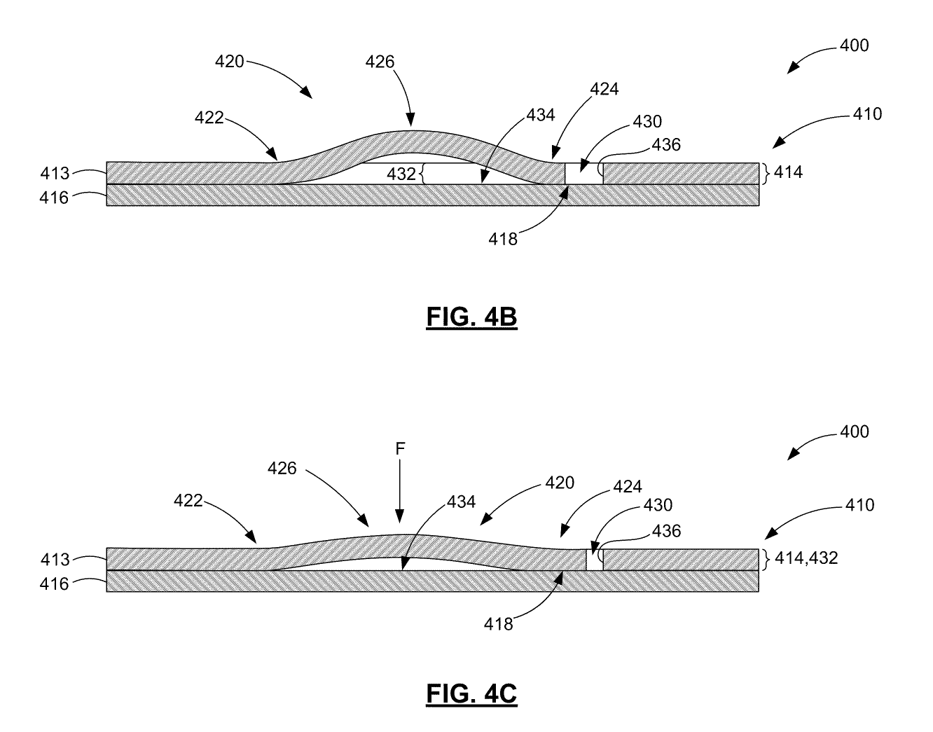

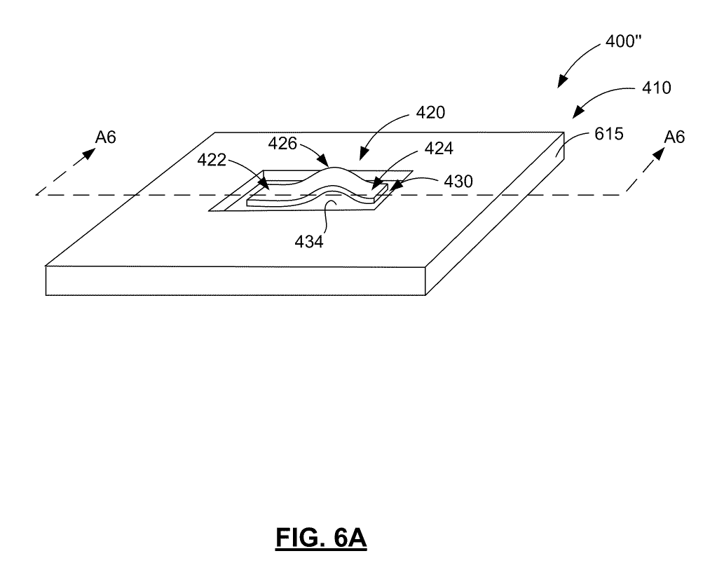

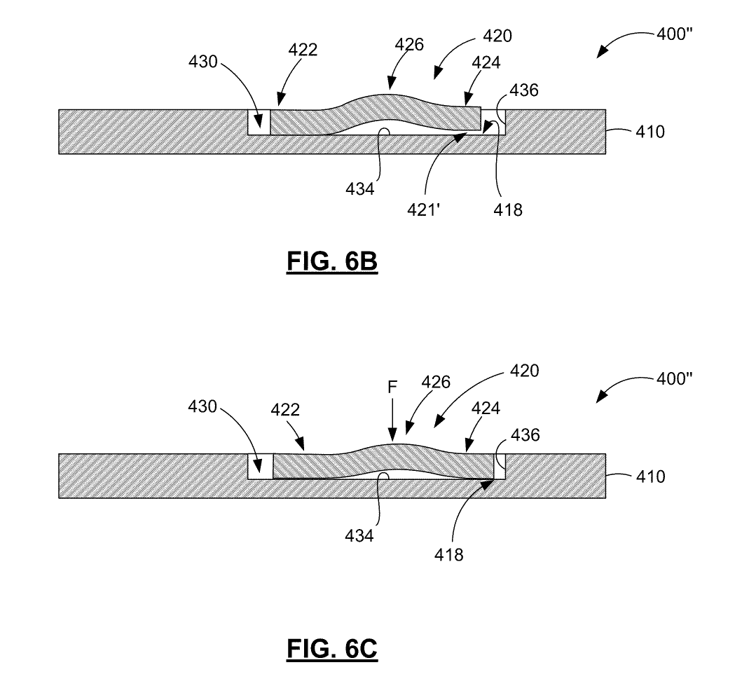

Referring now to FIGS. 4A, 4B, and 4C, a grounding component according to an embodiment of the present invention is shown generally as 400. With specific reference to FIG. 4A, which shows a perspective view of the grounding component 400, the grounding component 400 may have a grounded base 410. The grounded base 410 is configured to act as a floating ground for an electronic component by providing a reference potential for the electronic component when an electrical connection is established between the base 410 and the electronic component. The base 410 may consist of a top plate 413 secured to a bottom plate 416. Those of ordinary skill in the art will appreciate that the base 410 need not be made up of two plates. It may be desirable to use more than two plates, or in the alternative, to form the base as a single continuous plate. Exemplary embodiments utilizing single plate bases will be discussed in more detail below with reference to FIGS. 6A, 6B, and 6C.

With continuing reference to FIGS. 4A, 4B, and 4C, a cantilevered member 420, which may be in the form of a spring finger, may extend from the base 410. As illustrated, the spring finger 420 may be formed from a portion of the top plate 413 of the base 410. Those skilled in the art will appreciate that the spring finger 420 need not consist of a displaced portion of the top plate 413. Alternatively, and as will be discussed further below with reference to FIGS. 6A, 6B, and 6C, the spring finger 420 may be a separate component mechanically coupled to the base 410 by welding, adhesive, or one of many other known and suitable coupling means. Regardless of the nature of the connection between the spring finger 420 and the base 410, the spring finger 420 may have a fixed end 422 and a free end 424. The spring finger 420 is connected to the base 410 at its fixed end 422 which allows the spring finger 420 to flex and the free end 424 to move independently of the base 410 when a force is applied to the spring finger 420.

The spring finger 420 may be configured to have a knuckled portion 426 between its fixed 422 and free 424 ends. The knuckled portion 426 may be a portion of the spring finger 420 that lies proud of the base 410 (i.e. extends upwardly from the base 410). The knuckled portion 426 may be formed by bending the spring finger 420 into curvilinear form to produce a hump between the fixed end 422 and the free end 424 of the spring finger 420 (as best illustrated in FIG. 4B). Those skilled in the art will appreciate that the knuckled portion 426 may for example be formed as a smoothly curved surface and/or may be formed with sharp bends which may produce a spring finger 420 with a flat or a pointed apex. Various configurations are possible. As will be discussed below, the spring finger 420 will be subject to certain forces that will cause it to flex. Therefore, the spring finger 420 may comprise a suitably resilient material that can bend without failing in response to certain applied forces. As will be discussed in more detail below, the spring finger 420 comprises a conductive material. Examples of conductive and sufficiently resilient materials suitable for a spring finger 420 include, but are not limited to, stainless steel (e.g. SS 301, SS 304, and the like), aluminum, copper, tin, platinum, and silver.

A channel 430 may be formed out of the base 410 in order to accommodate the spring finger 420. In the case of a grounding component 400 having a base 410 consisting of two plates (such as that shown in FIGS. 4A, 4B, and 4C), the channel 430 may correspond to a void produced in the base 410 resulting from displacing the material comprising the spring finger 420 (as will be discussed below). Furthermore, the channel 430 may have a depth 432 approximately equal to the thickness 414 of the top plate 413. Where a grounding component has a base consisting of a single plate (such as grounding component 400″ in FIGS. 6A, 6B, and 6C), an appropriately shaped mold may be used to produce the base having a channel. In the single plate embodiment, the depth of the channel may be larger than the thickness of the spring finger.

It will be understood by those skilled in the art that the channel 430, as referred to herein, comprises a backstop portion 418 against which the free end 424 of the spring finger 420 will press when in a second depressed position (which will be described in further detail below). Referring briefly to FIG. 4B, in the embodiment depicted, a portion 418 of the upper surface of the bottom plate 416 (which serves as a floor 434 of the channel 430) provides the backstop portion 418 for the channel 430. The backstop portion 418 may be formed of metal or other material of suitable strength capable of being coupled to the base 410 in an appropriate location. As discussed below, the backstop portion 418 need not span the entire length of the channel 430. Those skilled in the art will appreciate that a hole through a single plate lacking a backstop portion is not intended to constitute a “channel” 430, as the term is used herein throughout (including in the claims).

FIG. 4B, which shows a sectional view of the grounding component 400 of FIG. 4A along section line A4-A4, illustrates the shape of the spring finger 420 of the grounding component 400. The spring finger 420 is shown in a first undepressed position. It can be said that the spring finger 420 is flexibly biased toward this first position as, in the absence of any externally applied forces, the spring finger 420 will settle in this position. When in the first position, the knuckled portion 426 of the spring finger 420 may lie proud of, or protrude from, the base 410. That is, when the grounding component 400, with the spring finger 420 in the first undepressed position, is viewed from the side, the knuckled portion 426 of the spring finger 420 may be elevated with respect to the base 410, and may be situated above the channel 430 formed in the base 410. The particular shape of the spring finger 420 may be such that the free end 424 of the spring finger 420 is redirected toward the base 410 and caused to lie substantially within the channel 430 of the base 410 when in the first undepressed position. In some instances at least one quarter of the thickness of the free end 424 of the spring finger 420 lies within the channel 430 when the spring finger 420 is in the first undepressed position. In other instances, the entire thickness 414 of the free end 424 of the spring finger 420 may lie within the channel 430 when the spring finger 420 is in the first undepressed position.

One advantage of configuring the free end 424 of the spring finger 420 to lie substantially within the channel 430 when the spring finger 420 is in the first undepressed position is that in this configuration, the channel 430 may partially protect the free end 424 of the spring finger 420 from snagging, and therefore may help to reduce the chances of the spring finger 420 sustaining damage by nearby moving objects during shipping and/or handling.

FIG. 4C illustrates a section view of the grounding component 400 of FIG. 4A along section line A4-A4 in a second depressed position as a result of a force F applied to the spring finger 420. The force F, which may be applied to the knuckled portion 426 of the spring finger 420, may act to push the spring finger 420 toward the channel 430. As indicated above, the backstop portion 418 of the base 410 acts as a backstop to the spring finger 420, limiting displacement of the free end 424 in the direction of the applied force F. In the embodiment illustrated, the portion of the bottom plate 416 defining the floor 434 of the channel 430 acts as the backstop portion 418. In other embodiments, the backstop may not extend the entire length of the channel 430. Those skilled in the art will appreciate that the backstop need only be present where contact is to be established between it and the free end 424 of the spring finger 420 as a result of the force F. The backstop may consist of any material having adequate hardness and strength properties to limit displacement of the free end 424 of the spring finger 420 in the direction of the applied force F.

The combination of the applied force F and the backstop portion 418 may cause the spring finger 420 to have a less pronounced knuckled portion 426 when in the second depressed position than when in the first undepressed position. That is, when the spring finger 420 is in the second depressed position, the knuckled portion 426 may protrude above the base 410 to a lesser extent than when in the first undepressed position. The shape of the free end 424 of the spring finger 420 may be configured such that the combination of the applied force F and the backstop may cause the free end 424 of the spring finger 420 to approach a far wall 436 of the channel 430.

The force F applied to the spring finger 420 (e.g. by a printed circuit board assembly, as discussed further below) causes the free end 424 of the spring finger 420 to move toward the floor 434 of the channel 430. The backstop portion 418 of the base 410 limits the vertical movement of the free end 424 of the spring finger 420, and as a result of the appropriate curvilinear shape of the spring finger 420, causes the spring finger 420 to partially flatten out as the free end 424 of the spring finger 420 moves toward the far wall 436 of the channel 430. A portion of the contact force exerted on the free end 424 of the spring finger 420 by the backstop portion 418 may cause the knuckled portion 426 of the spring finger 420 to exert a force against the source of the force F. The resulting increased contact force between the spring finger 420 and the source of the force F may help to ensure a consistent electrical connection between the base 410 and the source of the force F via the spring finger 420, which in turn may help ensure the continuous grounding of the source of the force F (e.g. a printed circuit board assembly) via the spring finger 420 and/or grounded base 410 (acting as a reference potential).

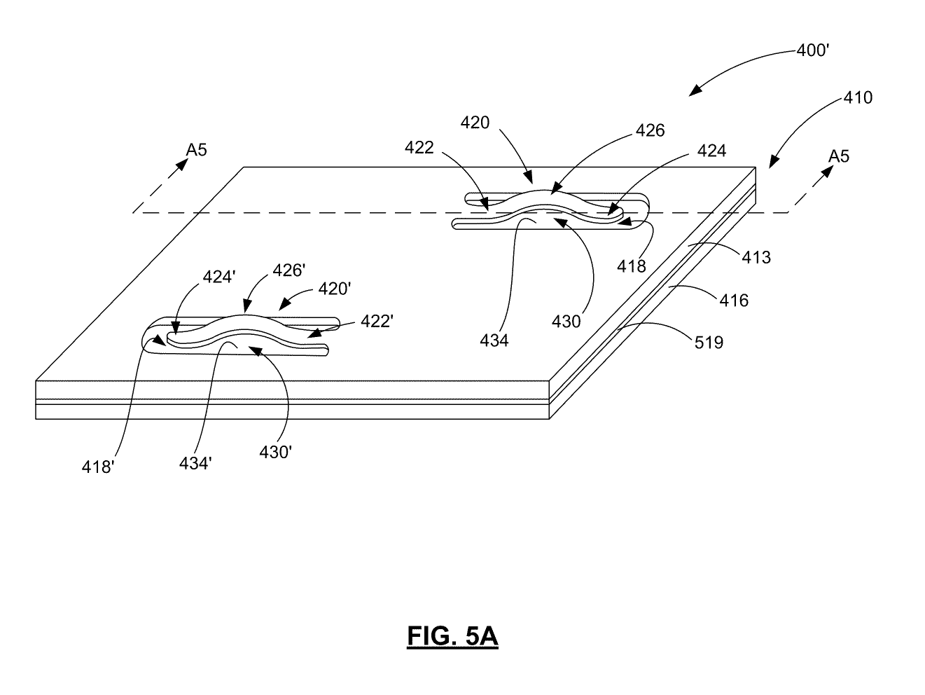

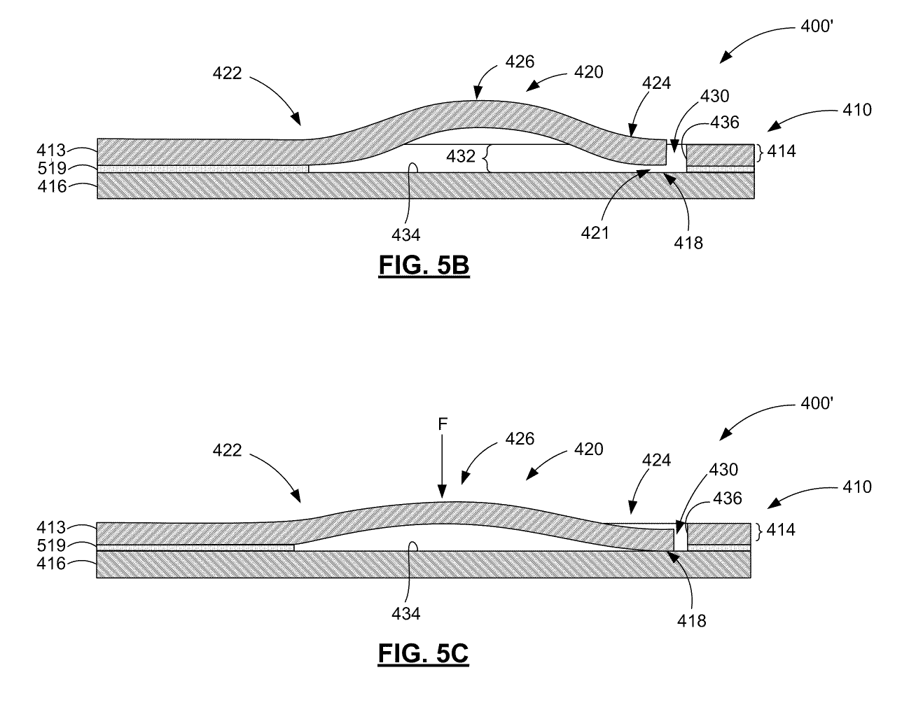

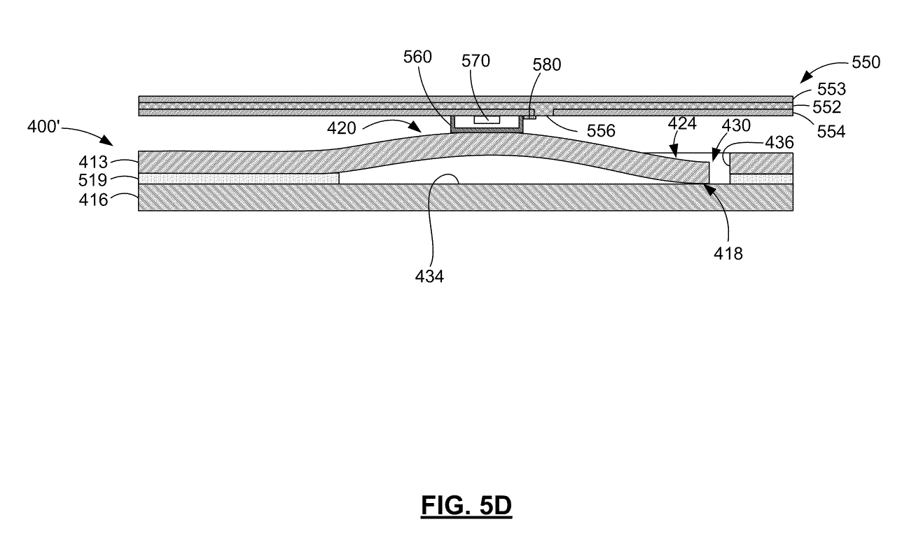

The spring finger 420 may comprise a conductive material, including but not limited to metals such as stainless steel (e.g. SS 301, SS 304, and the like), aluminum, copper, tin, platinum, and silver, in order for it to be a suitable electrical conductor. It will be appreciated by those skilled in the art that the electrical connection between the spring finger 420 and the backstop portion 418 of the base 410 is not required in order for the grounding component 400 to act as an electrical ground. The backstop may merely serve to apply a force to the spring finger 420 (at the free end 424) in a direction generally toward the source of the force F so as to help maintain the physical connection (and hence electrical connection) between the spring finger 420 and the source of the force F. Therefore, the backstop portion 418 of the base 410 need not be made of a conductive material. As discussed above, the backstop may be made of a material with strength characteristics suitable to counteract movement of the free end 424 of the spring finger 420 resulting from the applied force F. In some embodiments, as will be described further below with relation to FIG. 5D, it may be desirable to provide a conductive bottom plate 416 that may act to help shield against electromagnetic interference (EMI) emissions emanating from an electronic component mounted to, or otherwise operatively coupled to the grounding component 400.

Reference is now made to FIGS. 5A, 5B, 5C, and 5D which illustrate a grounding component 400′ according to another embodiment of the present invention. For clarity, elements in FIGS. 5A, 5B, 5C, and 5D similar to those in the embodiment of FIGS. 4A, 4B, and 4C are designated with the same reference numeral (which in some cases may also include an apostrophe).

The grounding component 400′ of the embodiment of FIG. 5A may have a plurality of spring fingers 420, 420′ and corresponding channels 430, 430′. The grounding component 400′ may include a first spring finger 420 having a first corresponding channel 430 and at least one second spring finger 420′ having a corresponding second channel 430′.

In this embodiment, the top plate 413 and bottom plate 416 of the grounded base 410 may be secured to one another using an adhesive 519. The adhesive 519 may be applied to the entire bottom surface of the top plate 413, or in the alternative, may be applied to a suitable number of predetermined locations on the bottom surface of the top plate 413 to hold the top and bottom plates 413, 416 together. In some instances, the adhesive 519 may act as a sealing agent and may be configured to prevent water, dust, and other impurities from reaching the channels 430, 430′ and hindering the performance of the grounding component 400′ (or any operatively coupled electronic component). Applying adhesive 519 to the entire bottom surface of the top plate 413 may be advantageous in that a larger layer of adhesive may provide a better seal for the channels 430, 430′ than adhesive 519 applied in localized zones. As discussed further below, the adhesive 519 used may be electrically conductive or non-conductive, depending on the particular application.

Specific reference is now made to FIG. 5B, in which a section view of the grounding component 400′ of FIG. 5A through section line A5-A5 is shown; the grounding component 400′ is depicted in a first undepressed position. As illustrated, the floor 434 of the channel 430 may be free of adhesive 519 so as to permit physical contact and electrical connection between the free end 424 of the spring finger 420 and the backstop portion 418 of the base 410 when the spring finger 420 is in the second depressed position. Ensuring that the floor 434 of the channel 430 is free of adhesive 519 may be necessary in embodiments in which the adhesive layer 519 is non-conductive. Such configurations may be necessary to ensure that an electrical connection may be established between the free end 424 and the bottom plate 416 of the base 410. In other embodiments—where the adhesive 519 and the bottom plate 416 of the base 410 are electrically conductive, and the spring finger 420 consists of a continuous portion of the top plate 413—an electrical connection may be established between the spring finger 420 and the bottom plate 416 when the spring finger 420 is in the first undepressed position via the electrically conductive adhesive 519 layer. In such embodiments, the electrical connection is established regardless of whether or not the free end 424 of the spring finger 420 is in contact with the backstop portion 418 of the base 410.

In those embodiments where it may be preferable to use an electrically non-conductive adhesive 519 to prevent electrical connection between the spring finger 420 and the bottom plate 416 when the spring finger 420 is in the first undepressed position, when the spring finger 420 is in the first undepressed position, the free end 424 of the spring finger 420 may be out of direct contact with the backstop portion 418 of the base 410, as illustrated by the gap 421 in FIG. 5B (and in contrast to the embodiment of FIG. 4B).

As in the embodiment depicted in FIGS. 4A, 4B, and 4C, when the spring finger 420, 420′ is in the first depressed position, the free end 424, 424′ of the spring finger 420, 420′ lies substantially within the channel 430, 430′ formed within the base 410 of the grounding component 400′. Accordingly, the underside of the free end 424 of the spring finger 420 is unexposed (or contained within the base 410), resulting in a grounding component 400′ having a spring finger with decreased susceptibility to snagging (and corresponding damage) while in the undepressed position—e.g. during shipping and handling of the grounding component 400′.

FIG. 5C shows a section view of the grounding component 400′ along section line A5-A5 (FIG. 5A); the grounding component 400′ is in a second depressed position as a result of a force F applied to the spring finger 420. As with the grounding component 400 of FIG. 4C, the force F may cause movement of the spring finger 420 toward the floor 434 of the channel 430. The force F may cause the spring finger 420 to partially flatten out, resulting in a less pronounced knuckled portion 426 in a depressed position than in an undepressed position. When the free end 424 of the spring finger 420 contacts the portion of the base 410 acting as the spring finger backstop, displacement of the free end 424 in the general direction of the applied force F may be translated into displacement along the channel 430 floor 434 toward the far wall 436 of the channel 430. Contact forces between the backstop portion 418 of the base 410 and the free end 424 of the spring finger 420, and the source of the force F and the spring finger 420, may establish an electrical connection between the respective components.

With reference to FIG. 5D, a section view of the grounding component 400′ along section line A5-A5 is shown; the grounding component 400′ is in a second depressed position as a result of a force F (as shown in FIG. 5C) exerted on the knuckled portion 426 of the spring finger 420 by an electrical contact point of an electronic component 550. In some embodiments the electronic component 550 may be a printed circuit board assembly 550. A printed circuit board assembly 550 may consist of a ground plane 552 located between two exterior layers 553, 554. The ground plane 552, which may be a conductive layer or a portion thereof, may be used as a common reference point for circuit returns. A portion of the ground plane 552 may penetrate the lower exterior layer 554 to form an exposed electrical contact point (or grounding pad) 556. Those of ordinary skill in the art will appreciate that the electrical contact point 556 may be flush with the bottom surface of the lower exterior layer 554 of the printed circuit board assembly 550, or alternatively may protrude from the bottom surface of the lower exterior layer 554.

In the embodiment shown, the printed circuit board assembly 550 has a metal or conductive-coated plastic case 560 to shield electro-magnetic interference (EMI) emissions emanating from a radio frequency (RF) chip 570 of the printed circuit board assembly 550. A solder joint 580 may connect the case 560 to the grounding pad 556 in order to establish an electrical connection between the two components. The metal case 560 may also be referred to as a metal can.

The printed circuit board assembly 550 and grounding component 400′ may be appropriately positioned and secured within a housing (not shown) of an electronic device such that the metal or conductive-coated case 560 exerts a downward force on the spring finger 420 of the grounding component 400′, causing the spring finger 420 to assume the second depressed position. Those ordinarily skilled in the art will appreciate that in alternate embodiments, the printed circuit board assembly 550 need not have a metal or conductive-coated case 560. In such embodiments, the printed circuit board assembly 550 and the grounding component 400′ may be secured within a housing (not shown) of an electronic device such that the knuckled portion 426 of the spring finger 420 lines up with the grounding pad 556 to establish direct physical contact (and hence an electrical contact) between the spring finger 420 and the electrical contact point 556 of the printed circuit board assembly 550 (e.g. the grounding pad).

In embodiments having a plurality of spring fingers 420, 420′ and corresponding channels 430, 430′, the printed circuit board assembly 550 may have a corresponding number of electrical contact points 556 (e.g. metal cans or grounding pads) for electrical engagement with the spring fingers 420, 420′ when the printed circuit board assembly 550 and grounding component 400′ are mounted within the housing of an electronic device. Some embodiments of the present invention may incorporate as many as eight or more spring fingers. Those skilled in the art will appreciate that grounding components according to the present invention may be manufactured with any number of spring fingers and corresponding channels. The number of spring finger and channel combinations may be dependent on the overall size of the electronic component to be grounded.

As mentioned above, the printed circuit board assembly 550 may be positioned with the housing of an electronic device. The electronic device may be a mobile device 100 as described above in relation to FIGS. 1 through 3. A mobile device 100 may include, but not be limited to a cellular telephone and/or a personal digital assistant (PDA). More specifically, the printed circuit board assembly may form part of the keypad assembly within a mobile device. The keypad assembly may include a keyboard 116 as described above in relation to FIG. 1. Example keypad assemblies that may be used with embodiments of the present invention include, but are not limited to, twelve-key telephone keypads and QWERTY keyboards. Those skilled in the art will appreciate that the grounding components according to the present invention may be used with any variation of keypad assembly.

As discussed briefly above, the bottom plate 416 need not comprise a conductive material in order for the grounding component 400′ to provide a reference ground to the electronic component 550. In some embodiments, however, it may be desirable to use a conductive bottom plate 416 as it may help shield a part of the surrounding environment from electromagnetic interference (EMI) emissions emanating from the electronic component 550.

Reference is now made to FIGS. 6A, 6B, and 6C, which illustrate another embodiment of the present invention. For clarity, elements in FIGS. 6A, 6B, and 6C similar to those in the embodiment of FIGS. 4A, 4B, and 4C are designated with the same reference numeral (which in some cases may also include a double apostrophe).

Grounding component 400″ is similar to grounding components 400, 400′ except that the grounded base 410 is made of a single plate 615. The channel 430 may be formed during the manufacturing of the plate 615 by selecting an appropriately shaped mold therefor. The spring finger 420 may be formed independently from the plate 615 and coupled to the floor 434 of the channel 430 formed within the base 410. The fixed end 422 of the spring finger 420 may be coupled to the base 410 using any suitable coupling means known in the art including, but not limited to, adhesive bonding and welding.

FIG. 6B shows a section view of the grounding component 400″ with the spring finger 420 in a first undepressed position. The free end 424 of the spring finger 420 may be remote from the floor 434 of the channel 430 when in this position.

As illustrated in FIG. 6C, and as described in more detail above with respect to FIG. 4C, the combination of a force F applied to the spring finger 420 (e.g. by a printed circuit board assembly) and the backstop portion 418 of the base 410 pushing back against the free end 424 of the spring finger 420, may result in a stronger contact force between the source of the force F and the spring finger 420. As further described above, the stronger contact force may help to ensure a consistent electrical connection between the base 410 and the source of the force F via the spring finger 420, which in turn may help ensure the continuous grounding of the source of the force F (e.g. a printed circuit board assembly) via the spring finger 420 and/or grounded base 410 (acting as a reference potential).

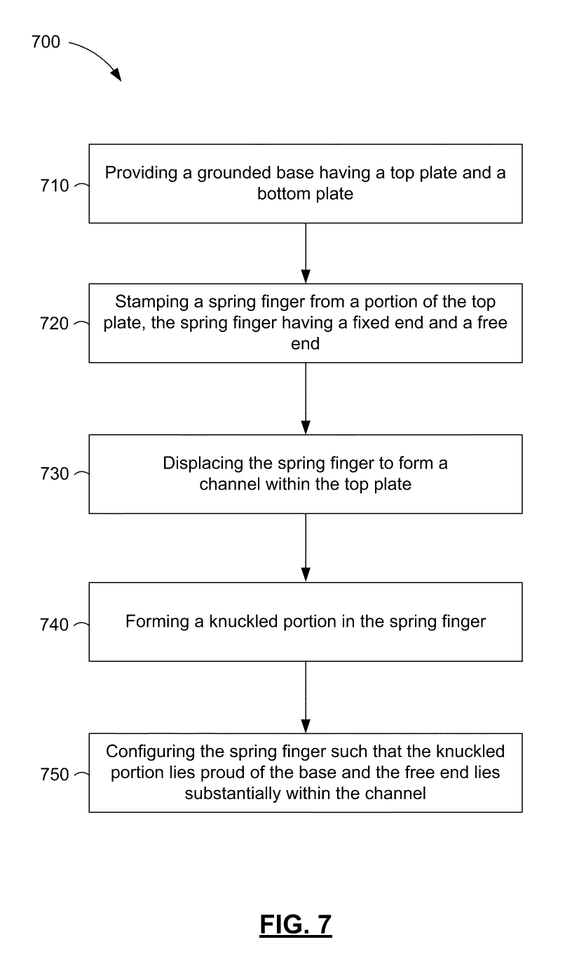

With reference to the logical flow diagram of FIG. 7, a method of manufacturing a grounding component (referred to generally as 700) will now be discussed. A grounded base 410, in some instances having a top plate 413 and a bottom plate 416, may be provided at Block 710. At Block 720, a spring finger 420 may be partially stamped from a portion of the top plate 413. The spring finger 420 may have a fixed end 422 and a free end 424. At Block 730, the spring finger 420 may be displaced to form a channel 430 within the top plate 413 of the base 410. At Block 740, a knuckled portion 426 may be formed in the spring finger 420. The knuckled portion 426 may be formed by bending or otherwise configuring the spring finger 420 to have a humped portion or raised apex between its fixed end 422 and its free end 424. At Block 750, the spring finger 420 may be configured such that the knuckled portion 426 lies proud of the base 410 and the free end 424 lies substantially within the channel 430 of the base 410.

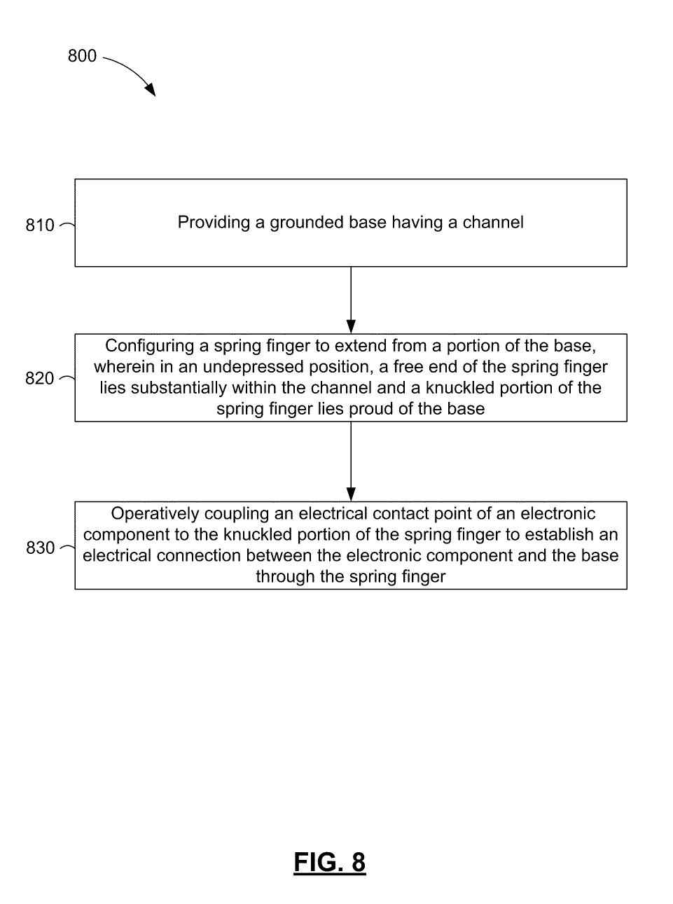

With reference to the logical flow diagram of FIG. 8, a method for grounding an electronic component (referred to generally as 800) will now be discussed. A grounded base 410 having a channel 430 may be provided at Block 810. As discussed above, the base 410 may comprise a single plate or may alternatively consist of a plurality of plates secured to one another. Where a plurality of plates makes up the base 410, the plates may be secured together using common coupling techniques including, but not limited to, adhesive bonding and welding. The bottom plate 416 of a multi-plated base may comprise a conductive or non-conductive material.

At Block 820, a spring finger 420 may be configured to extend from a portion of the base 410. The spring finger 420 may be formed as a part of a top plate 413 of a multi-plated base or may be a separate component coupled to a single- or multi-plated base. When the spring finger 420 is in an undepressed position, a free end 424 of the spring finger 420 is configured to lie substantially within the channel 430 of the base 410, and a knuckled portion 426 of the spring finger 420 is configured to lie proud of the base 410. The knuckled portion 426 of the spring finger 420 may be formed by bending a hump shape or pointed apex into the spring finger 420. The spring finger 420 may comprise a conductive material.

At Block 830, the electrical contact point 556 of an electronic component is operatively coupled to the knuckled portion 426 of the spring finger 420. Sustained physical contact between the electrical contact point 556 and the knuckled portion 426 may help to establish a consistent electrical connection between the electronic component and the base 410 via the spring finger 420. The spring finger 420 and base 410 may comprise an electrically conductive material (e.g. a metal or metal alloy) in order to act as a ground (or reference potential) for the electronic component when electrically coupled thereto. The consistent electrical connection between the electronic component and the base 410 (via the electrical contact point and the spring finger 420) may help ensure continuous grounding of the electronic component. The electronic component may comprise a printed circuit board assembly 550 of the type typically used in conjunction with a mobile device 100. Further the printed circuit board may form part of a keypad assembly.

The steps of a method in accordance with any of the embodiments described herein may not be required to be performed in any particular order, whether or not such steps are described in the claims or otherwise in numbered or lettered paragraphs.

The present grounding component has been described with regard to a number of embodiments. However, it will be understood by persons skilled in the art that other variants and modifications may be made without departing from the scope of the present disclosure as defined in the claims appended hereto.

1. A grounding component comprising:
(a) a grounded base;
(b) a channel formed within the base;
(c) a spring finger extending from the base, the spring finger having a fixed end and a free end; and
(d) wherein when the spring finger is in a first undepressed position, a knuckled portion of the spring finger lies proud of the base, and the free end of the spring finger lies substantially within the channel.

2. The grounding component of claim 1, wherein the base comprises a top plate secured to a bottom plate.

3. The grounding component of claim 2, wherein the top plate and bottom plate are secured using an adhesive.

4. The grounding component of claim 2, wherein the channel extends through an entire thickness of the top plate.

5. The grounding component of claim 2, wherein the spring finger is stamped from the top plate and displaced to form the channel within the top plate.

6. The grounding component of claim 3, wherein the adhesive is non-conductive and wherein when the spring finger is in a second depressed position, an electrical connection is established between the top plate and the bottom plate through the spring finger.

7. The grounding component of claim 1, wherein the fixed end of the spring finger is welded to the base.

8. The grounding component of claim 1, wherein the spring finger comprises a conductive material.

9. The grounding component of claim 1, further comprising at least one second channel and at least one second spring finger.

10. A grounding system comprising:
(a) a grounded base having a top plate secured to a bottom plate;
(b) a channel formed within the top plate;
(c) a cantilevered member extending from the base, the cantilevered member being flexibly biased towards a first undepressed position; and
(d) wherein in a second depressed position, the cantilevered member is in electrical contact with the bottom plate.

11. The grounding system of claim 10, wherein the cantilevered member has a free end and a fixed end, and wherein when the cantilevered member is in the first undepressed position, a knuckled portion of the cantilevered member lies proud of the base, and the free end of the cantilevered member lies substantially within the channel.

12. The grounding system of claim 10, wherein when the cantilevered member is in the first undepressed position, the top plate and the bottom plate are not in electrical communication.

13. The grounding system of claim 10, further configured for receivably mounting an electronic component to the base, and wherein when the electronic component is mounted to the base, an electrical connection is established between the electronic component and the base through the cantilevered member, for grounding the electronic component.

14. The grounding system of claim 13, wherein the electronic component comprises a printed circuit board assembly.

15. The grounding system of claim 14, further comprising a keypad assembly coupled to the printed circuit board assembly.

16. An assembly for grounding an electronic component comprising:
(a) a grounded base;
(b) a channel formed in the base;
(c) a cantilevered member extending from the base, the cantilevered member being flexibly biased towards a first undepressed position, and having a fixed end and a free end;
(d) wherein when the cantilevered member is in the first undepressed position, a knuckled portion of the cantilevered member lies proud of the base and the free end of the cantilevered member lies substantially within the channel; and,
(e) wherein when the electronic component is mounted to the base, an electrical connection is established between the base and the electronic component through the cantilevered member.

17. The assembly of claim 16, wherein the cantilevered member comprises a conductive material.

18. The assembly of claim 16, wherein at least a portion of the base comprises a conductive material for reducing electro-magnetic interference emissions generated from the electronic component.

19. The assembly of claim 16, wherein the electronic component is a printed circuit board assembly, and wherein the printed circuit board assembly is mounted within a mobile device.

20. The assembly of claim 19, further comprising a keypad assembly coupled to the printed circuit board assembly.
